(19) United States
(12) Patent Application Publication
(10) Pub. No.: US 2008/0129222 A1
(43) Pub. Date: Jun. 5, 2008

(54) Multi-lamp driving system and current balance circuit thereof

(75) Inventors: Wei Chen, Taoyuan Hsien (TW); Deng-Yan Zhou, Taoyuan Hsien (TW); Zeng-Yi Lu, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS INC.

(21) Appl. No.: 11/976,422

(22) Filed: Oct. 24, 2007

(30) Foreign Application Priority Data
Dec. 1, 2006 (TW) 95144575

(51) Int. Cl. H05B 41/36

(52) U.S. Cl. 315/294

(57) ABSTRACT

The invention provides multi-lamp systems includes a driving circuit, a transformer coupled to the driving circuit, a feedback circuit coupled to the driving circuit, a lamp set coupled to the feedback circuit and having at least two lamps connected in parallel, and a current balance circuit coupled between the transformer and the lamps. The current balance circuit includes at least one capacitor and at least one balance transformer. The balance transformer is coupled between a first lamp and a second lamp, and the capacitor is coupled parallel to one side of the balance transformer.

### CROSS REFERENCE TO RELATED APPLICATIONS

This Non-provisional application claims priority under 35 U.S.C. §119(a) on Patent Application No(s). 095144575 filed in Taiwan, Republic of China on Dec. 1, 2006, the entire contents of which are hereby incorporated by reference.

### BACKGROUND OF THE INVENTION

1. Field of the Invention

The invention relates to a lamp driving system and in particular, to a multi-lamp driving system and current balance circuits thereof.

2. Description of the Related Art

Flat panel monitors are currently available to all applications, with Liquid Crystal Display (LCD) seeing widest application. Providing sufficient brightness for large LCD, the number of lamps in the backlight module is increased. The lamps in the backlight module are generally implemented by cold cathode fluorescent lamps (CCFLs). For example, a 40 inch LCD may require as many as 30 CCFLs to ensure brightness. It becomes critical to maintain unique brightness as the number of lamps in the module is increased.

FIG. 1A illustrates a conventional CCFL driving system 1. The system 1 includes a driving circuit 11, a transformer 12, a plurality of capacitors C, a plurality of CCFLs 14 and a feedback circuit 13. A voltage source Vᵢₙ coupled to the driving circuit 11 is transformed to a transformed voltage level by the main transformer 12. The feedback circuit 13 controls the driving circuit 11 according to the voltage level or current of one of the CCFLs 14 to adjust the voltage supplied to the main transformer 12, and the brightness of the CCFLs 14 varies with the voltage supplied to the main transformer 12.

In the conventional technique shown in FIG. 1A, to maintain uniform brightness, each of the CCFLs 14 is coupled to a capacitor C having large capacitance in series. The capacitors C with higher impedance than the CCFLs 14 ensure equalization between currents through different CCFLs 14, but occupy most of the voltage supplied by the main transformer 12. To maintain the CCFLs 14 at sufficient operating voltage, the winding count of the secondary winding of the main transformer 12 has to be increased, and the size and power consumption of the CCFL driving system 1 are increased accordingly.

FIG. 1B illustrates another conventional CCFL driving system 1′. The system 1′ includes a driving circuit 11, a main transformer 12, an impedance matching network 15, a plurality of CCFLs 14 and a feedback circuit 13. A voltage source Vᵢₙ coupled to the driving circuit 11 is transformed to a transformed voltage level by the main transformer 12. The feedback circuit 13 controls the driving circuit 11 according to the voltage level or current of one of the CCFLs 14 to adjust the voltage supplied to the main transformer 12, and the brightness of the CCFLs 14 varies with the voltage supplied to the main transformer 12.

In the conventional technique shown in FIG. 1B, uniform brightness of the CCFLs 14 is maintained by adjusting impedance matching relationship through the impedance matching network 15 applied in the system 1′. The impedance matching network 15 includes two high voltage capacitors C (corresponding to the two CCFLs 14 shown in FIG. 1B) and one inductor L. The high voltage capacitors C are coupled to the CCFLs 14 in series, respectively. The inductor L is electrically coupled between the capacitors C, and also electrically coupled between the two CCFLs 14. The impedance matching network 15 can slightly improve uniformity of currents through different CCFLs 14, but is sensitive to the on/off frequency of the switch of the system 1′ and the variation in load. Furthermore, design of the impedance matching network 15 is overly complicated and the effect on uniform brightness is minimal.

Lamp driving systems that address such shortcomings and improve current and brightness uniformity are thus called for.

### BRIEF SUMMARY OF THE INVENTION

The invention provides a multi-lamp driving system and current balance circuits thereof providing equivalent current for lamps avoiding problems associated with conventional techniques.

In an embodiment of the invention, a multi-lamp driving system includes a driving circuit, a main transformer electrically coupled to the driving circuit, a feedback circuit electrically coupled to the driving circuit, a lamp set electrically coupled to the feedback circuit and having at least two lamps connected in parallel, and a current balance circuit electrically coupled to the lamps and having at least one capacitor and a balance transformer. The balance transformer is electrically coupled between a first lamp and a second lamp of the lamp set. The capacitor is coupled to one side of the balance transformer in parallel.

In another embodiment of the invention, a multi-lamp driving system includes a driving circuit, a main transformer electrically coupled to the driving circuit, a feedback circuit electrically coupled to the driving circuit, a lamp set electrically coupled to the feedback circuit and having at least two lamps connected in parallel, and a current balance circuit electrically coupled between the main transformer and the lamp set and having at least one capacitor and at least one couple inductor. The couple inductor includes at least two windings coupled to the lamps in series, respectively. The capacitor is coupled to one of the windings in parallel.

In another embodiment of the invention, a multi-lamp driving system includes a driving system, a main transformer electrically coupled to the driving circuit, a feedback circuit electrically coupled to the driving circuit, a lamp set electrically coupled to the feedback circuit and having at least two lamps connected in parallel, and a current balance circuit electrically coupled between the main transformer and the lamp set and having at least two capacitors and at least two mutually coupled balance transformers. The balance transformers are electrically coupled to the lamps. Each of the capacitors is coupled to one side of one of the balance transformers in parallel.

The invention provides a multi-lamp driving system in which one side of the balance transformer or one winding of the couple inductor is coupled to a capacitor in parallel. Compared with conventional techniques, the invention provides uniform current for the lamps with simplified design. The invention provides good performance and uniform brightness in large LCDs.

The above and other advantages will become more apparent with reference to the following description taken in conjunction with the accompanying drawings.

### BRIEF DESCRIPTION OF THE DRAWINGS

The invention will become more fully understood from the subsequent detailed description and the accompanying drawings, which are given by way of illustration only, and thus are not limitative of the present invention, and wherein:

FIG. 1A illustrates a conventional CCFL driving system;

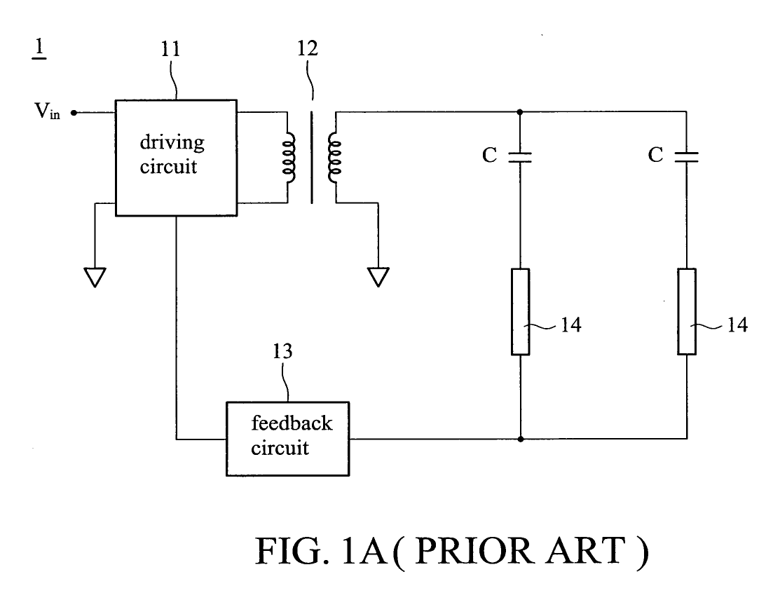

FIG. 1B illustrates another conventional CCFL driving system;

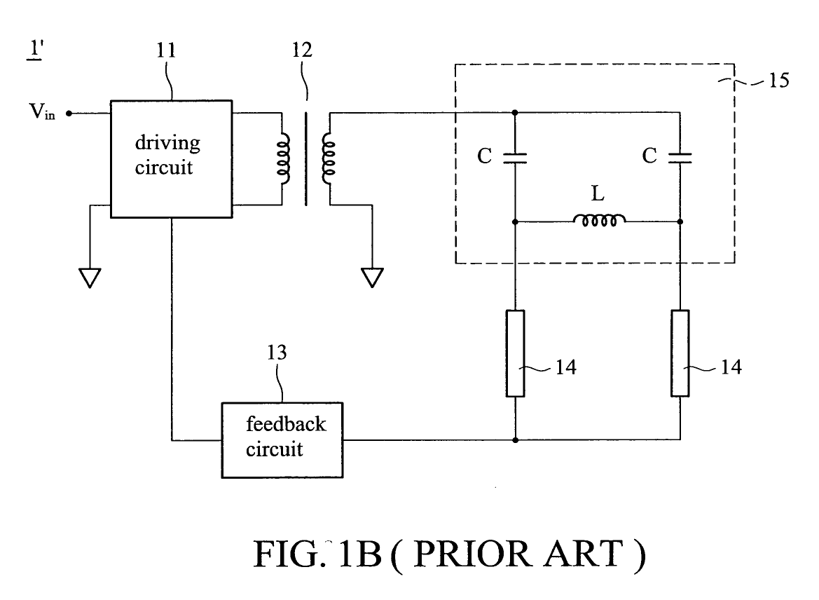

FIG. 2 illustrates an embodiment of the multi-lamp driving system of the invention;

FIG. 3 illustrates an equivalent circuit of the current balance circuit shown in FIG. 2;

FIG. 4 illustrates another embodiment of the multi-lamp driving system of the invention;

FIG. 5 illustrates another embodiment of the multi-lamp driving system of the invention;

FIG. 6 illustrates another embodiment of the multi-lamp driving system of the invention; and

FIG. 7 illustrates another embodiment of the multi-lamp driving system of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

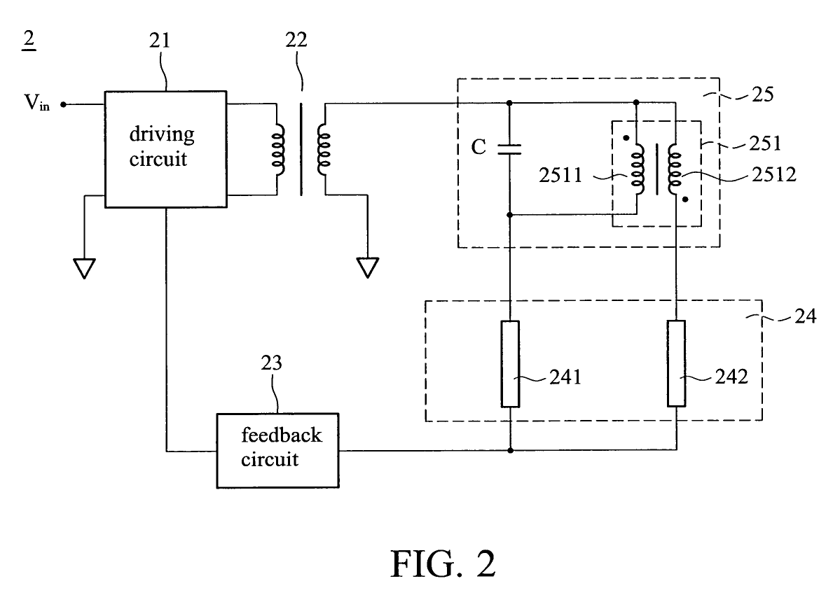

FIG. 2 illustrates an embodiment of the multi-lamp driving system 2 of the invention. The multi-lamp driving system 2, which can be applied to a backlight set (not shown), includes a driving circuit 21, a main transformer 22, a feedback circuit 23, a lamp set 24, and a first current balance circuit 25. A voltage source Vᵢₙ is coupled to the driving circuit 21 and is transformed to a transformed voltage level by the main transformer 22. According to the current or voltage signal of one lamp of the lamp set 24, the feedback circuit 23 controls the driving circuit 21 to adjust the voltage supplied to the main transformer 22.

In such a case, the lamp set 24 includes a first lamp 241 and a second lamp 242 coupled to an input terminal of the feedback circuit 23. The lamps used in the embodiment are cold cathode fluorescent lamps (CCFLs).

The first current balance circuit 25 is electrically coupled between the main transformer 22 and the lamp set 24 to receive the transformed voltage from the main transformer 22 and provide the first and second lamps 241, 242 with equivalent current. The first current balance circuit 25 includes at least one capacitor C and a balance transformer 251. The balance transformer 251 is electrically coupled between the first and second lamps 241, 242. The capacitor C is coupled to one side of the balance transformer 251 in parallel. The balance transformer 251 includes a primary winding 2511 and a secondary winding 2512. The capacitor C and the primary winding 2511 are coupled in parallel. The primary winding 2511 includes a first terminal and a second terminal. The first terminal of the primary winding 2511 is electrically connected to a first terminal of the capacitor C and the main transformer 22. The second terminal of the primary winding 2511 is electrically connected to a second terminal of the capacitor C and the first lamp 241. The secondary winding 2512 includes a first terminal and a second terminal. The first terminal of the secondary winding 2512 is electrically coupled to the first terminal of the primary winding 2511 and the main transformer 22. The second terminal of the secondary winding 2512 is electrically coupled to the second lamp 242.

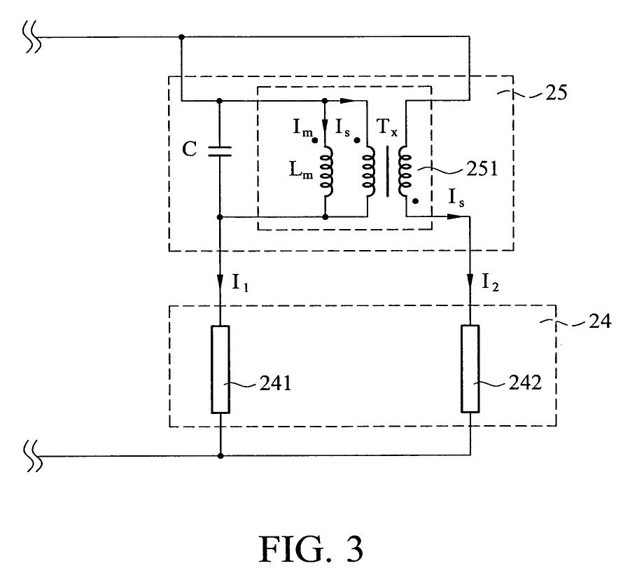

FIG. 3 illustrates an equivalent circuit of the first current balance circuit 25 of FIG. 2. The equivalent circuit of the balance transformer 251 includes an ideal transformer Tₓ and a magnetizing inductor Lₘ. The current through the primary side of the ideal transformer Tₓ and the secondary side of the ideal transformer Tₓ normally have the same value of Iₛ because the number of windings of the primary winding is equivalent to that of the secondary winding. In a circuit without the capacitor C, the current through the first lamp 241 (I₁) is the sum of current through the primary side (Iₛ) and through the magnetizing inductor Lₘ (Iₘ). In such a case, to ensure that the current through the first lamp (I₁) is equivalent to that through the second lamp 242 (I₂), the inductance of the inductor Lₘ has to be much higher than 1H to ensure the current through the inductor Lₘ is relatively small. The production cost of the inductor with large inductance is high because the process of iron-core and winding is complicated. As shown in FIG. 3, a capacitor C is coupled to the primary side of the balance transformer 251 in parallel to form a parallel resonance circuit with the inductor Lₘ. By properly setting the value of the capacitor C and the inductor Lₘ, the resonance frequency is set at the on/off frequency of the entire circuit. Because the impedance of the parallel resonance circuit is very high at the resonance frequency, the branch current through the capacitor C and the inductor Lₘ is relatively small. Therefore, current through the first lamp (I₁) approximates the current through the second lamp (I₂) and approximates the current through the primary and secondary sides of the ideal transformer (Iₛ).

The capacitor C is not limited to couple to the primary side of the balance transformer 251 in parallel. In other embodiments, the capacitor C can be coupled to the secondary side of the balance transformer 251 in parallel, or to both the primary and secondary sides of the balance transformer 251 in parallel.

Furthermore, the capacitor C can be implemented by parasitic capacitance of the winding of the balance transformer 251. With proper design of the winding, the parasitic capacitance of the winding plays the role of the capacitor C and is capable of equalizing the current through the first lamp and that through the second lamp.

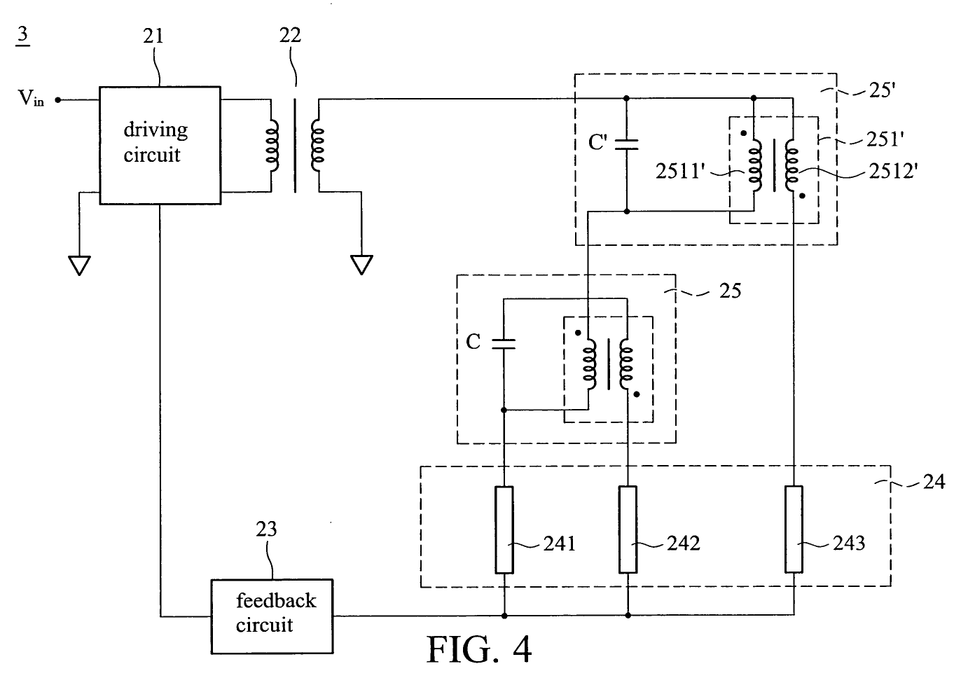

FIG. 4 illustrates another embodiment of the multi-lamp driving system of the invention. Compared to the multi-lamp driving system 2 shown in FIG. 2, the multi-lamp driving system 3 shown in FIG. 4 further includes a second current balance circuit 25′ and a third lamp 243. The second current balance circuit 25′ includes the same components as the first current balance circuits 25. A first terminal of the primary winding 2511′ is electrically coupled to a first terminal of capacitor C′ and the main transformer 22. The secondary terminal of the primary winding 251′ is electrically coupled to a secondary terminal of the capacitor C′. A first terminal of the secondary winding 2512′ is electrically coupled to the first terminal of the primary winding 251′ and the main transformer 22. A secondary terminal of the secondary winding 2512′ is electrically coupled to the third lamp 243.

In such a case, the current through the first and second lamps 241, 242 is equalized by the first current balance circuit 25, and that through the second and third lamps 242, 243 is equalized by the second current balance circuit 25′. Therefore, the system 3 is capable of equalizing the current through the first, second and third lamps 241, 242, 243.

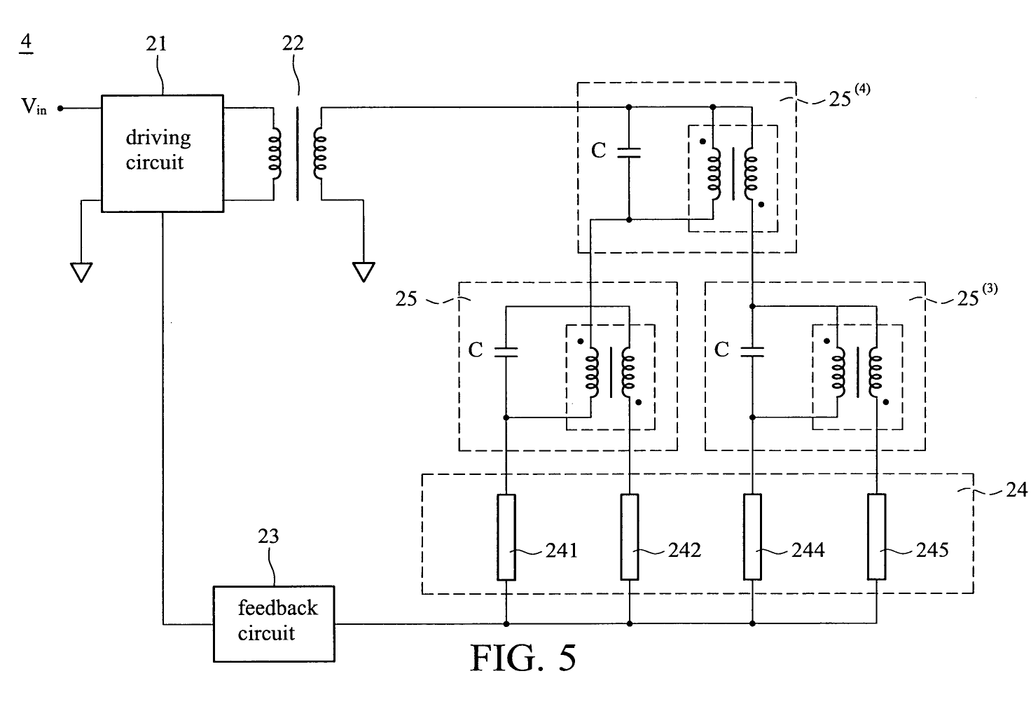

FIG. 5 illustrates another embodiment of the multi-lamp driving system of the invention. Compared to the multi-lamp driving system 2, the multi-lamp driving system 4 further includes a third current balance circuit 25⁽³⁾, a fourth current balance circuit 25⁽⁴⁾, a fourth lamp 244, and a fifth lamp 245. As shown in FIG. 5, the third and fourth current balance circuits 25⁽³⁾ and 25⁽⁴⁾ have the same components as the first current balance circuit 25. The connection between the third current balance circuit 25⁽³⁾, the fourth lamp 244 and the fifth lamp 245 is similar to that between the first current balance circuit 25, the first lamp 241 and the second lamp 242.

The fourth current balance circuit 25⁽⁴⁾ is electrically coupled to the main transformer 22, and is coupled between the first and third current balance circuits 25, 25⁽³⁾. The current into the first and third current balance circuits 25, 25⁽³⁾ is equalized by the fourth current balance circuit 25⁽⁴⁾. Because the current from the fourth current balance circuit 25⁽⁴⁾ to the first and third current balance circuits 25, 25⁽³⁾ is equivalent, the current through the first, second, fourth, and fifth lamps (241, 242, 244, and 245) generated by the first and third current balance circuits 25, 25⁽³⁾ is equivalent.

When the number of lamps in the lamp set 24 is N, the multi-lamp system includes (N−1) current balance circuits arranged in a tree form (as that shown in FIG. 5).

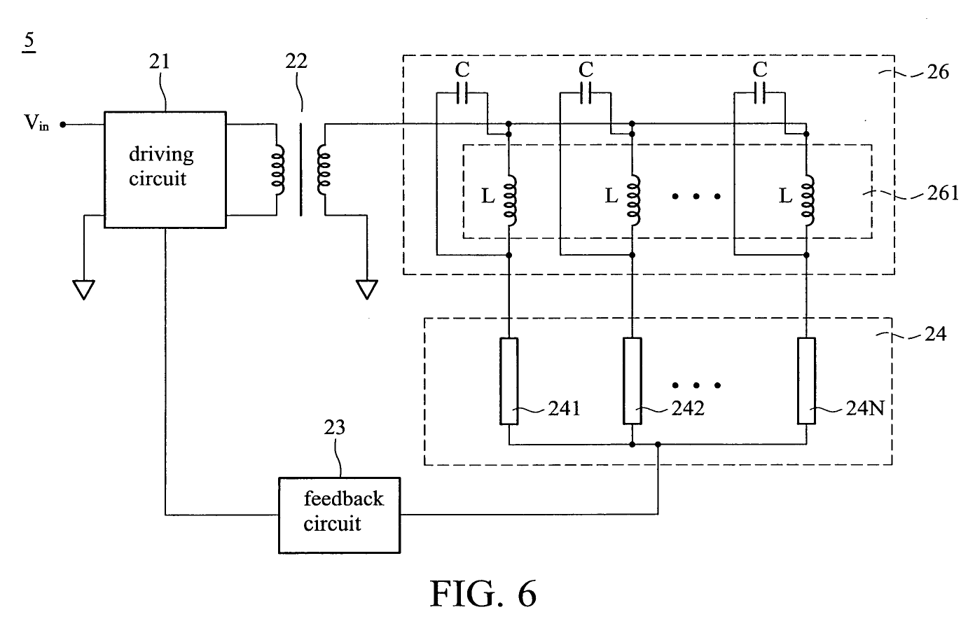

FIG. 6 illustrates another embodiment of the multi-lamp driving system of the invention. Compared to the multi-lamp driving system 2 shown in FIG. 2, the difference in the multi-lamp driving system 5 is that the first current balance circuit 25 is replaced with a current balance circuit 26. The number of lamps of the embodiment is N (numbered 241˜24N).

The current balance circuit 26 includes a couple inductor 261 and a plurality of capacitors C. The couple inductor 261 includes a plurality of windings L. In such a case, corresponding to the lamps (241˜24N), the number of the capacitors C and the number of the windings L are both N. The capacitors C are coupled to the windings L in parallel, respectively. Each set of the capacitor C and the winding L is a parallel resonance circuit. By properly setting the values of the capacitor C and the winding L, the resonance frequency is adjusted to the on/off frequency of the system, and the impedance of the parallel resonance circuit is high and the current through the parallel resonance circuit is very small. Therefore, the current through the lamps 241˜24N is uniform.

Furthermore, the current balance circuit includes fewer capacitors C coupled to only some of the windings L in parallel. For example, when a capacitor C is coupled to the winding L corresponding to the lamp 241 in parallel, the current through the lamp 241 is equalized to that through the lamp 242.

In some embodiments, the parasitic capacitance of the balance transformer 251 and that of the windings L are utilized to replace the capacitors of the parallel resonance circuits. In such cases, the parasitic capacitance is retained without being eliminated by other additional circuits.

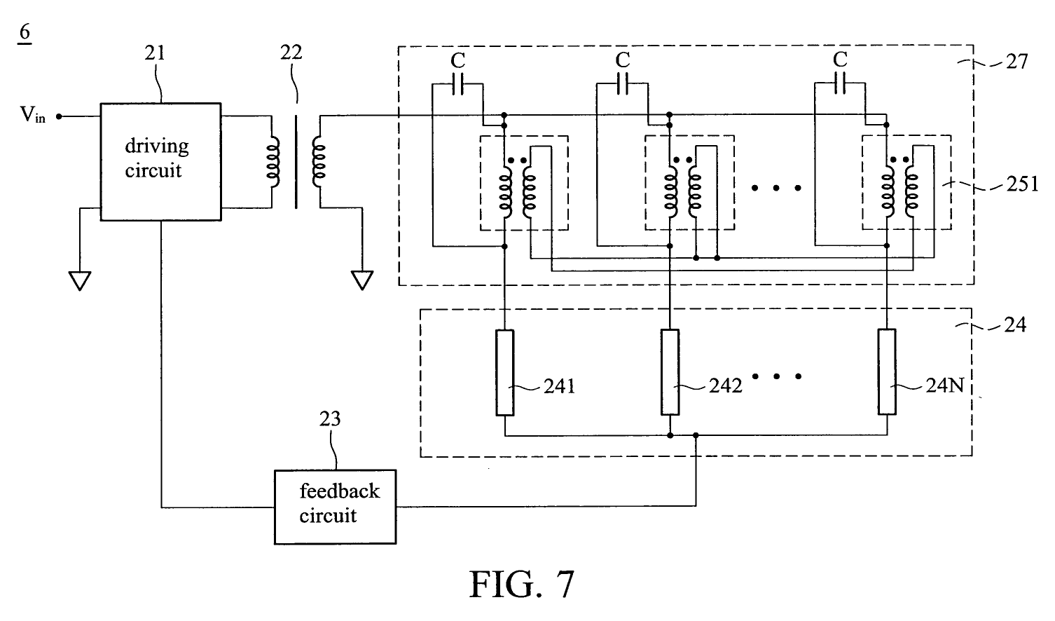

FIG. 7 illustrates another embodiment of the multi-lamp driving system of the invention. Compared to the multi-lamp driving system 2 shown in FIG. 2, the difference in the multi-lamp driving system 6 is that the current balance circuit 25 is replaced with a current balance circuit 27. As shown in FIG. 7, the number of lamps in the lamp set 24 is N, marked as 241˜24N.

The current balance circuit 27 includes a plurality of balance transformers 251 and a plurality of capacitors C corresponding to the lamps 241˜24N. The number of the balance transformer 251 is N, and the same as that of the capacitors C. Each of the capacitor C is coupled to one side of the corresponding balance transformer 521 in parallel to form a parallel resonance circuit. As the aforementioned embodiments, the resonance frequency of the parallel resonance circuits are set at the on/off frequency of the circuit by properly setting the value of the capacitor C and the magnetizing inductor Lₘ to decrease the current through the capacitors C and the magnetizing inductor Lₘ. Therefore, the current through every lamp is uniform.

According to the present invention, the current balance circuit can be arranged between the lamps and the feedback circuit rather than between the main transformer and the lamps. In such cases, the current balance circuit still provides impedance matching for the lamps and maintains the uniformity of the currents through the lamps.

The invention provides multi-lamp driving system and current balance circuits thereof. The current balance circuits include capacitors. The capacitors are coupled to one side of balance transformers or one side of a couple inductor in parallel to form parallel resonance circuits. By setting the parallel resonance circuits at appropriate resonance frequency, current through the parallel resonance circuits is lowered and that through the lamps is equalized. Compared to conventional techniques, the design is simplified and performance improved when the balance circuit is realized in large display panels.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded to the broadest interpretation so as to encompass all such modifications and similar arrangements.

What is claimed is:

1. A multi-lamp driving system comprising:
a driving circuit;
a main transformer connected to the driving circuit;
a feedback circuit connected to the driving circuit;
a lamp set connected to the feedback circuit and having a first lamp and a second lamp connected in parallel; and
a first current balance circuit coupled with the lamp set and having a first capacitor and a first balance transformer,
wherein the first balance transformer is electrically coupled with the first and second lamps, and the first capacitor is coupled to one side of the first balance transformer in parallel.

2. The multi-lamp driving system as claimed in claim 1, further comprising a second current balance circuit having a second capacitor and a second balance transformer, and a third lamp connected to the first and second lamps in parallel, the second capacitor is connected to the first current balance circuit, and the second balance transformer is connected to the third lamp.

3. The multi-lamp driving system as claimed in claim 1, further comprising a third current balance circuit having a third capacitor and a third balance transformer, a fourth current balance circuit having a fourth capacitor and a fourth balance transformer, a fourth lamp, and a fifth lamp, wherein the third current balance circuit is connected to the fourth and fifth lamps, and the fourth current balance circuit is connected to the main transformer and coupled between the first and third current balance circuits.

4. The multi-lamp driving system as claimed in claim 3, wherein the fourth capacitor is connected to the first current balance circuit, and the fourth balance transformer is connected to the third current balance circuit.

5. The multi-lamp driving system as claimed in claim 1, wherein the first balance transformer comprises an ideal transformer and a magnetizing inductor, and the first capacitor is coupled to a primary side or a secondary side of the ideal transformer in parallel to form a parallel resonance circuit with the magnetizing inductor.

6. The multi-lamp driving system as claimed in claim 1, wherein the first balance transformer has a parasitic capacitance.

7. The multi-lamp driving system as claimed in claim 1, wherein the first and second lamps are cold cathode fluorescent lamps.

8. The multi-lamp driving system as claimed in claim 1, wherein the first balance transformer comprises:
a primary winding, having a first terminal and a second terminal, wherein the first terminal is connected to a first terminal of the first capacitor and the main transformer, and the second terminal is connected to a second terminal of the first capacitor and the first lamp; and
a secondary winding having a third terminal and a fourth terminal, wherein the third terminal is connected to the primary winding and the main transformer, and the fourth terminal is connected to the second lamp.

9. A multi-lamp driving system comprising:
a driving circuit;
a main transformer connected to the driving circuit;
a feedback circuit connected to the driving circuit;
a lamp set connected to the feedback circuit and having a first lamp and a second lamp connected in parallel; and
a current balance circuit coupled with the lamp set and having a capacitor and a couple inductor, wherein the couple inductor comprises a first winding coupled in series with the first lamp and a second winding coupled in series with the second lamp, and the capacitor is coupled parallel to one side of the first and second windings.

10. The multi-lamp driving system as claimed in claim 9, wherein the capacitor is coupled in series with one of the first and second lamps to form a parallel resonance circuit with the first and second windings.

11. The multi-lamp driving system as claimed in claim 9, wherein the first and second lamps are cold cathode fluorescent lamps.

12. The multi-lamp driving system as claimed in claim 9, wherein the first or second winding has a parasitic capacitance.

13. A multi-lamp driving system comprising:
a driving circuit;
a main transformer connected to the driving circuit;
a feedback circuit connected to the driving circuit;
a lamp set connected to the feedback circuit and having a first lamp and a second lamp connected in parallel; and
a current balance circuit coupled between the main transformer and the lamp set, and having a first capacitor, a second capacitor, a first balance transformer and a second balance transformer, wherein the first and second balance transformers are coupled to the first and second lamps, respectively, and are coupled therewith in series, and the first and second capacitors are coupled to the first and second balance transformers in parallel, respectively.

14. The multi-lamp driving system as claimed in claim 13, wherein the first and second capacitors are coupled to the first and second lamps in series, respectively.

15. The multi-lamp driving system as claimed in claim 13, wherein the first balance transformer comprises an ideal transformer and a magnetizing inductor, and the first capacitor is coupled parallel to a primary side or a secondary side of the ideal transformer to form a parallel resonance circuit with the magnetizing inductor.

16. The multi-lamp driving system as claimed in claim 13, wherein the first or second balance transformer has a parasitic capacitance.

17. The multi-lamp driving system as claimed in claim 13, wherein the first or second balance transformer comprises:
a primary winding having a first terminal and a second terminal, wherein the first terminal is connected to a first terminal of the first capacitor, and the second terminal is connected to a second terminal of the second capacitor and one of the first and second lamps; and
a secondary winding coupled to the secondary winding of another balance transformer in series.

18. The multi-lamp driving system as claimed in claim 13, wherein the first and second lamps are cold cathode fluorescent lamps.

19. The multi-lamp driving system as claimed in claim 13, wherein the current balance circuit comprises a couple inductor having two windings, and each of the windings is coupled in series with the corresponding lamp and has a parasitic capacitance.
